(19) United States
(12) Patent Application Publication
(10) Pub. No.: US 2011/0107072 A1
(43) Pub. Date: May 5, 2011

(54) METHOD FOR SELF-DIAGNOSING SYSTEM MANAGEMENT INTERRUPT HANDLER

(75) Inventors: Ying-Chih Lu, Taipei City (TW); Po-Chin Yang, Taipei City (TW)

(73) Assignee: INVENTEC CORPORATION, Taipei City (TW)

(21) Appl. No.: 12/766,247

(22) Filed: Apr. 23, 2010

(30) Foreign Application Priority Data
Nov. 2, 2009 (TW) 98137164

(51) Int. Cl. G06F 15/177; G06F 11/22; G06F 12/02

(52) U.S. Cl. 713/1; 714/731; 711/102; 711/E12.007; 714/E11.149

(57) ABSTRACT

A method for self-diagnosing a system management interrupt (SMI) handler is provided. A first time value is obtained from an advanced configuration and power interface (ACPI) timer at a time of executing the SMI handler. And a source path of a SMI is obtained. Then, a second time value is obtained from the ACPI timer at a time of finishing the SMI handler. An execution time is obtained according to the first time and the second time. If the execution time is greater than or equal to a time-out value, related information of the SMI is recorded.

### CROSS-REFERENCE TO RELATED APPLICATION

This application claims the priority benefit of Taiwan application serial no. 98137164, filed on Nov. 2, 2009. The entirety of the above-mentioned patent application is hereby incorporated by reference herein and made a part of specification.

### BACKGROUND OF THE INVENTION

1. Field of the Invention

The present invention relates to a system management interrupt (SMI) mechanism. More particularly, the present invention relates to a method for self-diagnosing a SMI.

2. Description of Related Art

A system management mode (SMM) is a special function of a central processing unit (CPU) used in a general personal computer system. When a system management interrupt (SMI) is triggered to the CPUs, all of the CPUs receive such signal and enter the system management mode. A basic input output system (BIOS) can execute a SMI handler under the system management mode to serve the SMI.

Generally, if the computer system has a plurality of the CPUs, only one of the CPUs is used to execute the SMI handler, and the other CPUs are in a waiting state, and wait for completing the above SMI handler. Therefore, the SMI greatly influences a system operation and a performance thereof.

However, the operation of the computer system only focuses on a correctness of the SMI handler function. Namely, when the SMI is occurred, the SMI handler implements a corresponding function according to the SMI. Therefore, whether an execution process of the SMI handler is reasonable or is in compliance with a specification (for example, whether the SMI handler is time-out and whether a usage rate of the CPU is excessive, etc.) is often overlooked.

### SUMMARY OF THE INVENTION

Accordingly, the present invention is directed to a method for self-diagnosing a system management interrupt (SMI) handler, by which the SIM handler can self-diagnose whether a processing process thereof is reasonable or is in compliance with a specification.

The present invention provides a method for self-diagnosing a SMI handler, which is suitable for a computer system. When a SMI is triggered to a central processing unit (CPU), the CPU executes the SMI handler. Then, a first time value is obtained from an advanced configuration and power interface (ACPI) timer at a time of executing the SMI handler. Moreover, a source path of the SMI is obtained. Thereafter, after execution of the SMI handler is finished, a second time value is obtained from the ACPI timer at a time of finishing the SMI handler. Then, an execution time of the SMI handler is compared to a time-out value. If the execution time is greater than or equal to the time-out value, the execution time, the source path and the time-out value are recorded in a memory.

In an embodiment of the present invention, before the SMI is triggered to the CPU, a basic input output system (BIOS) is used to execute a power on self test (POST), so as to initialize a SMI mechanism. Moreover, when the SMI mechanism is initialized, a first timestamp is read from a real time clock (RTC) chip through the BIOS, and is recorded in the memory.

In an embodiment of the present invention, when the CPU executes the SMI handler, a second timestamp is further obtained from the RTC chip, so as to calculate a usage rate of the CPU according to the first timestamp and the second timestamp. Steps of calculating the usage rate of the CPU are as follows. First, after execution of the SMI handler is finished, a difference between the second timestamp and the first timestamp is added to the execution time, so as to obtain a total time passed through from starting of the computer system till now. Next, the execution time and a value of an accumulation time field are accumulated, so as to obtain an accumulated time of the execution time of the SMI handler that is accumulated from starting of the computer system till now. Next, the usage rate of the CPU is calculated according to the accumulated time and the total time.

In an embodiment of the present invention, after execution of the SMI handler is finished, the usage rate of the CPU is compared to an upper limit. If the usage rate of the CPU is greater than or equal to the upper limit, the source path of the SMI, the second timestamp, the usage rate of the CPU and the upper limit are recorded in the memory.

In an embodiment of the present invention, after execution of the SMI handler is finished, the accumulated time is written in the accumulation time field for calculating the accumulated time during a next execution of the SMI handler.

In an embodiment of the present invention, if the execution time is greater than or equal to the time-out value, the second timestamp is recorded in the memory.

In an embodiment of the present invention, after the SMI handler is executed, if the SMI handler is hanged, a predetermined value is recorded in a hang state field, and the second timestamp and the source path of the SMI are recorded in the memory.

In an embodiment of the present invention, the memory is a non-volatile random access memory (NVRAM).

According to the above description, in the present invention, when the SMI handler is executed, related information of an abnormal SMI is recorded, so that when a user inspects a record in the NVRAM, the user can get to know whether an abnormity is occurred to the SMI handler, for example, whether the SMI handler is ever time-out, or whether the usage rate of the CPU ever exceeds the upper limit, and even can get to know whether or not the computer system is ever hanged during execution of the SMI handler. Therefore, the user can find and fix the abnormity to ensure a rationality that the computer system executes the SMI handler, and ensure a stability and efficiency of the computer system.

In order to make the aforementioned and other features and advantages of the present invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart illustrating a method for self-diagnosing a SMI handler according to a first embodiment of the present invention.

FIG. 2 is a schematic diagram illustrating a source path of a SMI according to an embodiment of the present invention.

FIG. 3 is a schematic diagram illustrating a computer system according to a second embodiment of the present invention.

FIG. 4 is a flowchart illustrating a method for self-diagnosing a SMI handler according to a second embodiment of the present invention.

### DESCRIPTION OF THE EMBODIMENTS

Generally, operation of a computer system only focuses on a correctness of a system management interrupt (SMI) handler function, and whether an execution process of the SMI handler is reasonable or is in compliance with a specification (for example, whether the SMI handler is time-out or whether a usage rate of a central processing unit (CPU) is excessive, etc.) is often overlooked. Therefore, the present invention provides a method for self-diagnosing the SMI handler, by which the SIM handler can self-diagnose whether a processing process thereof is reasonable or is in compliance with the specification. In order to make the spirit of the present invention comprehensible, several exemplary embodiments accompanied with figures are described in detail below.

### First Embodiment

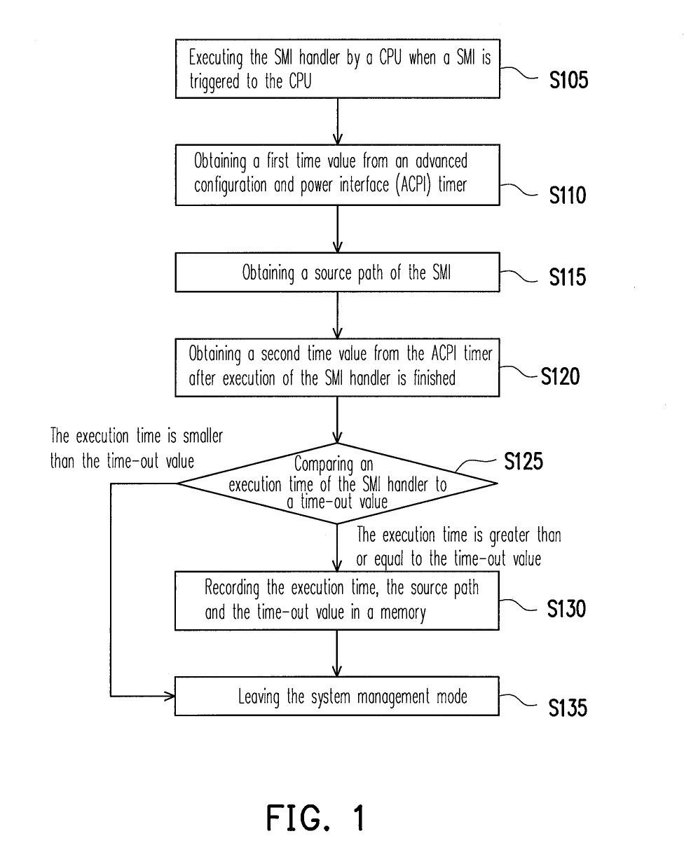

FIG. 1 is a flowchart illustrating a method for self-diagnosing a SMI handler according to the first embodiment of the present invention. Referring to FIG. 1, in step S105, when the SMI is triggered to the CPU, the CPU executes the SMI handler. Here, a program code can be, for example, added in the SMI handler, so that the SMI handler can perform the self-diagnosis.

In detail, the SMI is an interrupt with a highest priority, which includes a software SMI, a hardware SMI and a periodic SMI. The software SMI is a SMI triggered when software performs a write operation to an input/output port. The hardware SMI is a SMI triggered when hardware detects a certain event. The periodic SMI is a SMI triggered to the CPU by a chip every a fixed period of time.

Once the SMI is triggered to the CPU, the CPU immediately enters a system management mode (SMM). When the CPU is in the SMM, the CPU immediately writes a context thereof, i.e. values of all registers of the CPU into a SMM random access memory (RAM), and then the CPU skips to an entry of the SMI to execute the SMI handler.

Next, in step S110, a first time value is obtained from an advanced configuration and power interface (ACPI) timer at a time of executing the SMI handler, which is a time point when the SMI handler is started to be executed. Here, since a time resolution of the ACPI timer is relatively high, the time can be accurately calculated, so that it is used as a basis of time unit, so as to record a time spent for executing each SMI handler.

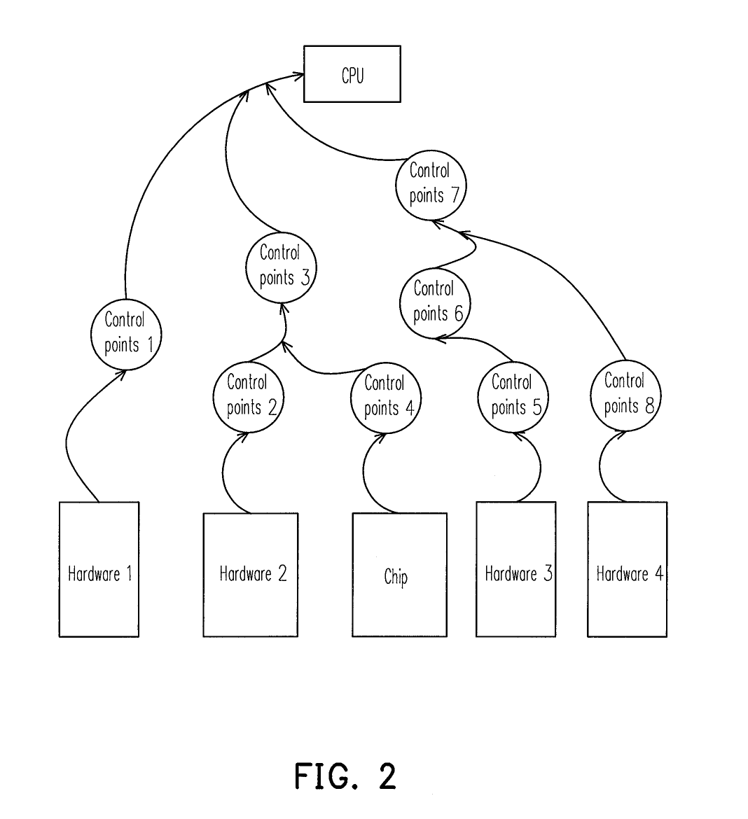

Next, in step S115, a source path of the SMI is obtained. The source path is referred to a path that is passed through for triggering the SMI, i.e. a path of all control points that are passed through from a source device where the SMI is sent to the CPU. For example, FIG. 2 is a schematic diagram illustrating the source path of the SMI according to an embodiment of the present invention. Referring to FIG. 2, a source path of the SMI of hardware 1 is a control point 1. A source path of the SMI of hardware 2 is control points 2 and 3. A source path of the SMI of a chip is control points 4 and 3. A source path of the SMI of hardware 3 is control points 5, 6 and 7. A source path of the SMI of hardware 4 is control points 8 and 7. Here, the control points that the SMI transmitted from the source device (for example, the hardware 1-4 and the chip) to the CPU passes through are required to be all enabled, so as to trigger the CPU.

In the present embodiment, a method for representing the source path is, for example, {control point 1, control point 2, . . . }. Each of the control points is represented by (state bit, enable bit). Moreover, the state bit and the enable bit are respectively represented by an input/output (IO) address and a bit offset thereof. For example, {((IO address of the state bit, offset of the state bit), (IO address of the enable bit, offset of the enable bit))}.

Next, in step S120, after execution of the SMI handler is finished, a second time value is obtained from the ACPI timer of at a time of finishing the SMI handler, which is a time point when execution of the SMI handler is finished.

Next, in step S125, an execution time of the SMI handler is compared to a time-out value. Here, the execution time is a difference between the second time value and the first time value.

It should be noticed that the time-out value can be input by a user or obtained from an operating system, or can be dynamically obtained (for example, a cycle set by a periodic interrupt of a real time clock (RTC) chip can be read, for example, a cycle of 1/18.2 second). Here, the user can set the time-out value of the SMI handler through a BIOS setting menu, though other situations can also be deduced.

If the execution time is greater than or equal to the time-out value, as that shown in step S130, the execution time, the source path and the time-out value are recorded in a memory. Here, the memory is, for example, a non-volatile random access memory (NVRAM). In other embodiments, the SMI handler can further record the execution time, the source path and the time-out value in a system event log (SEL) through a baseboard management controller (BMC), and stores the SEL in the NVRAM.

Finally, in step S135, the CPU executes a resume (RSM) instruction, so as to leave the system management mode. Moreover, the above context of the CPU is obtained from the SMM RAM, and is written into the registers of the CPU. Then, an interrupted program point where the SMI is occurred is resumed.

Since each execution time of the SMI handler is limited, and miss of other important interrupts due to execution of the SMI handler is unacceptable, whether the SMI handler is time-out is required to be determined For example, assuming the periodic system timer generates 18.2 interrupts per second, and some of which serve as ticks of the system time, and some of which serve as a timer base for the operating system processing schedules. If execution of one of the SMI handlers exceeds 1/18.2 second, renew of one tick is lost, which can lead to a time error of the system. Therefore, according to the above steps S105-S135, the related information of the time-out SMI can be recorded for later inquiry.

Besides a situation that the execution time of the SMI handler is time-out, a usage rate of the CPU, and situations such as whether the SMI handler is hanged during execution can also influence an operation and performance of the computer system. Another embodiment is provided below for further description.

### Second Embodiment

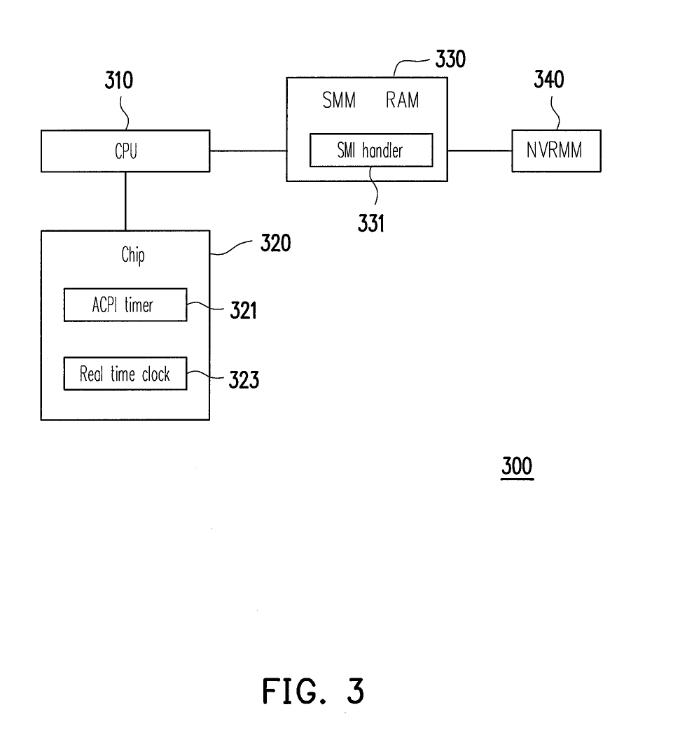

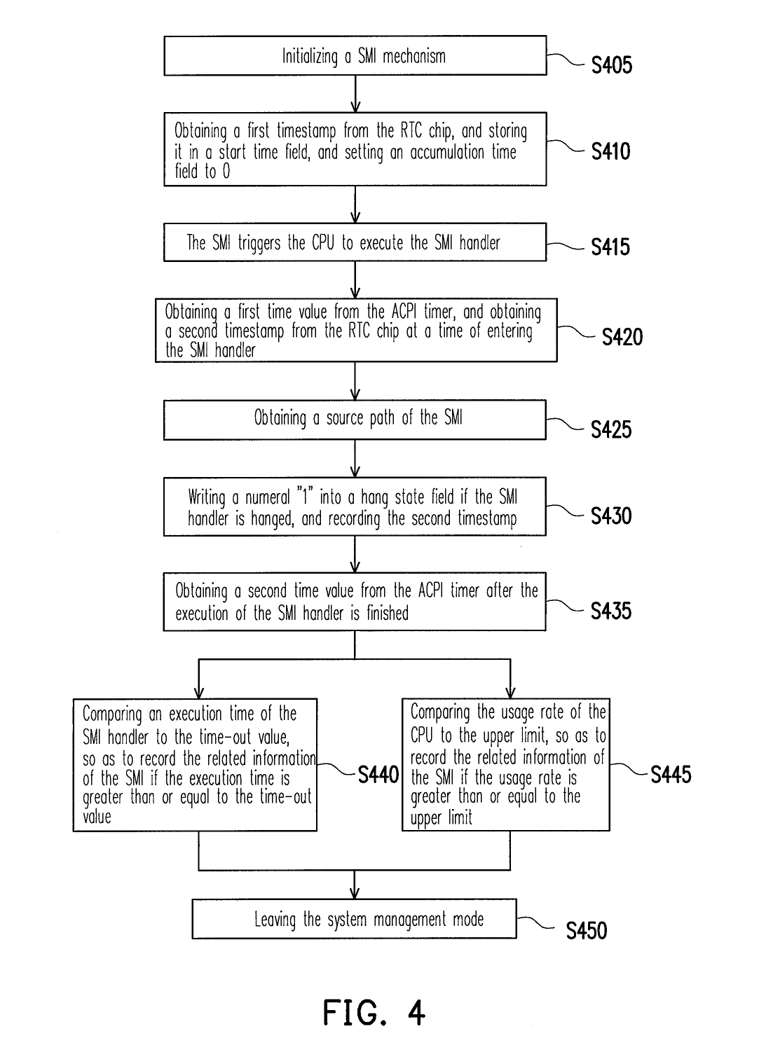

FIG. 3 is a schematic diagram illustrating a computer system according to a second embodiment of the present invention. FIG. 4 is a flowchart illustrating a method for self-diagnosing a SMI handler according to the second embodiment of the present invention.

Referring to FIG. 3, in the present embodiment, the computer system 300 includes a CPU 310, a chip 320, a SMM RAM 330 and a NVRAM 340. Wherein, the chip 320 includes an ACPI timer 321 and a RTC chip 323. Moreover, the SMM RAM 330 stores a SMI handler 331. Here, the chip 320 can send a SMI to the CPU 310, so that the CPU 310 executes the SMI handler 331 stored in the SMM RAM 330. If an abnormity is occurred during the self-diagnosing process of the SMI handler 331, the SMI handler 331 can store the related information of the abnormal SMI in the NVRAM 340. In the other embodiments, the SMI handler 331 can further record the related information of the abnormal SMI in a SEL through a BMC (not shown), and stores the SEL in the NVRAM 340.

Steps of the self-diagnosis of the SMI handler 331 are described in detail below.

Referring to FIG. 3 and FIG. 4, first, in step S405, a basic input output system (BIOS) (not shown) is used to execute a power on self test (POST), so as to initialize a SMI mechanism.

It should be noticed that during the POST process, the user can determine whether or not entering a BIOS setting menu to perform settings (for example, whether or not enabling the self-diagnosing function of the SMI handler 331, and setting the time-out value of the SMI handler 331 and the upper limit of the usage rate of the CPU 310, etc.) according to an actual demand.

Next, in step S410, a first timestamp is read from the RTC chip 323 through the BIOS, and is stored in a start time field in the NVRAM 340. Moreover, an accumulation time field of the SMI handler 331 in the NVRAM 340 is set to 0. Here, the start time field is used for calculating the usage rate of the CPU 310.

Next, in step S415, when the SMI is triggered to the CPU 310 through the chip 320, the CPU 310 executes the SMI handler 331 in the SMM RAM 330. For example, a program code can be added to the SMI handler 331, so that the SMI handler 331 can perform the self-diagnosis. Here, the step S415 is similar to the step S105 of the first embodiment, and therefore detailed description thereof is not repeated.

Next, in step S420, a first time value is obtained from the ACPI timer 321, and a second timestamp is obtained from the RTC chip 323 at a time of entering the SMI handler 331, so as to calculate the usage rate of the CPU 310 according to the first timestamp and the second timestamp. Here, the time-out value and the upper limit of the usage rate of the CPU can be fetched from the values stored through the BIOS setting menu. Moreover, the first timestamp and an accumulated time (an initial value thereof is 0, and is accumulated by each execution time of the SMI handler) are respectively obtained from the start time field and the accumulation time field in the NVRAM 340.

Next, in step S425, a source path of the SMI is obtained. Such step is the same to the step S115 of the first embodiment, and therefore detailed description thereof is not repeated. Moreover, the step of obtaining the source path of the SMI can also be executed after the step S415, which is not limited by the present invention.

During execution of the SMI handler 331, in step S430, if the SMI handler 331 is hanged, a numeral “1” is written into a hang state field in the NVRAM 340, and the second timestamp and the source path of the SMI are recorded in the memory. Namely, if a value of the hang state field is 1, it represents that the SMI handler 331 is hanged. If values of a plurality of hang state fields in the NVRAM 340 are all 1, or if there is none hang state field in the NVRAM 340, when the SMI handler 331 is hanged, a new hang state field is established in the NVRAM 340, and the numeral “1” is written into the new hang state field, and meanwhile the source path of the SMI and the second timestamp are recorded in the memory. Moreover, if there is only one hang state field in the NVRAM 340, and a value thereof is 0, when the SMI handler 331 is hanged, the numeral “1” is directly written into the hang state field, and meanwhile the source path of the SMI and the second timestamp are recorded in the memory.

Next, after the execution of the SMI handler 331 is finished, in step S435, a second time value is obtained from the ACPI timer 321. Next, steps S440 and S445 are executed.

The step S440 is the same to the steps S125 and S130 of the first embodiment, and therefore detailed description thereof is not repeated. In the step S440, an execution time (a difference between the second time value and the first time value) of the SMI handler 331 is compared to the time-out value. If the execution time is greater than or equal to the time-out value, the source path of the SMI is recorded, and meanwhile the execution time, the time-out value and the second timestamp are recorded.

In the step S445, the usage rate of the CPU is compared to the upper limit. If the usage rate is greater than or equal to the upper limit, the source path of the SMI, the second timestamp, the usage rate of the CPU and the upper limit are recorded. The usage rate of the CPU is calculated according to the first time value, the second time value, the first timestamp and the second timestamp. Here, the first time value is assumed to be t1, the second time value is assumed to be t2, the first timestamp is assumed to be ts1, and the second timestamp is assumed to be ts2.

In detail, after the execution of the SMI handler 331 is finished, a difference tt between the second timestamp and the first timestamp is calculated, and the difference tt is converted to a value ttt with a unit of the ACPI timer 321. Then, the value ttt is added to the execution time of the SMI handler 331 to obtain a total time passed through from starting of the computer system till now, i.e. ttt+t2−t1. Moreover, the execution time and a value ACT of the accumulation time field are accumulated to obtain an accumulated time t of the execution time of the SMI handler 331 that is accumulated from starting of the computer system 300 till now, i.e. t=(t2−t1)+ACT. Thereafter, a usage rate CU of the CPU is calculated according to the accumulated time and the total time, i.e. CU=(t/(ttt+t2−t1))*100.

It should be noticed that after the execution of the SMI handler 331 is finished, a numeral “0” is written into the hang state field, which represents that the current SMI handler 331 is not hanged. Moreover, the SMI handler 331 also records the accumulated time t in the accumulation time field.

Finally, in step S450, the CPU 310 executes a resume (RSM) instruction, so as to leave the system management mode. Here, the step S450 is the same to the step S135 of the first embodiment, and therefore detailed description thereof is not repeated.

In summary, in the present invention, when the SMI handler is executed, related information of an abnormal SMI is recorded, so that the user can obtain the SMI when the SMI handler is ever time-out, or the SMI when the usage rage of the CPU ever exceeds the upper limit by inspecting a record in the NVRAM, and even get to know whether or not the computer system is ever hanged during execution of the SMI handler. Therefore, the user can find and fix the abnormity to ensure a rationality that the computer system executes the SMI handler, and ensure a stability and efficiency of the computer system.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for self-diagnosing a system management interrupt (SMI) handler, suitable for a computer system, the method for self-diagnosing the SMI handler comprising:
executing the SMI handler by a central processing unit (CPU) when a SMI is triggered to the CPU;
obtaining a first time value from an advanced configuration and power interface (ACPI) timer at a time of executing the SMI handler;
obtaining a source path of the SMI;
obtaining a second time value from the ACPI timer at a time of finishing the SMI handler after execution of the SMI handler is finished;
comparing an execution time of the SMI handler to a time-out value, wherein the execution time is equal to a difference between the second time value and the first time value; and
recording the execution time, the source path and the time-out value in a memory if the execution time is greater than or equal to the time-out value.

2. The method for self-diagnosing the SMI handler as claimed in claim 1, wherein before the SMI is triggered to the CPU, the method further comprises:
executing a power on self test (POST) through a basic input output system (BIOS), so as to initialize a SMI mechanism; and
reading a first timestamp from a real time clock (RTC) chip through the BIOS, and recording the first timestamp in the memory.

3. The method for self-diagnosing the SMI handler as claimed in claim 2, wherein when the CPU executes the SMI handler, the method further comprises:
obtaining a second timestamp from the RTC chip, so as to calculate a usage rate of the CPU according to the first timestamp and the second timestamp.

4. The method for self-diagnosing the SMI handler as claimed in claim 3, wherein the step of calculating the usage rate of the CPU comprises:
adding a difference between the second timestamp and the first timestamp to the execution time after execution of the SMI handler is finished, so as to obtain a total time passed through from starting of the computer system till now;
accumulating the execution time and a value of an accumulation time field, so as to obtain an accumulated time of the execution time of the SMI handler that is accumulated from starting of the computer system till now; and
calculating the usage rate of the CPU according to the accumulated time and the total time.

5. The method for self-diagnosing the SMI handler as claimed in claim 4, wherein after execution of the SMI handler is finished, the method further comprises:
writing the accumulated time in the accumulation time field.

6. The method for self-diagnosing the SMI handler as claimed in claim 3, wherein after execution of the SMI handler is finished, the method further comprises:
comparing the usage rate of the CPU to an upper limit; and
recording the source path, the second timestamp, the usage rate of the CPU and the upper limit in the memory if the usage rate of the CPU is greater than or equal to the upper limit.

7. The method for self-diagnosing the SMI handler as claimed in claim 3, wherein if the execution time is greater than or equal to the time-out value, the method further comprises:
recording the second timestamp in the memory.

8. The method for self-diagnosing the SMI handler as claimed in claim 3, wherein after the CPU executes the SMI handler, the method further comprises:
recording a predetermined value in a hang state field, and recording the second timestamp and the source path of the SMI in the memory if the SMI handler is hanged.

9. The method for self-diagnosing the SMI handler as claimed in claim 1, wherein the memory is a non-volatile random access memory (NVRAM).
